(19) United States
(12) Patent Application Publication
(10) Pub. No.: US 2011/0318081 A1
(43) Pub. Date: Dec. 29, 2011

(54) IMAGE FORMING APPARATUS AND IMAGE FORMING METHOD

(75) Inventors: Yoshiaki Kaneko, Shizuoka-ken (JP); Hirofumi Kondo, Kanagawa-ken (JP); Ken Iguchi, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/169,111

(22) Filed: Jun. 27, 2011

Related U.S. Application Data
(60) Provisional application No. 61/359,149, filed on Jun. 28, 2010.
(60) Provisional application No. 61/384,040, filed on Sep. 17, 2010.

(51) Int. Cl. B41J 11/02

(52) U.S. Cl. 400/611

(57) ABSTRACT

According to one embodiment, an image forming apparatus includes a curl forming unit, an endless device, an attracting unit, and an image forming unit. The curl forming unit forms a curl in a recording medium. The endless device holds the recording medium in which the curl is formed by the curl forming unit. The attracting unit applies attraction force for attraction to the surface of the endless device to the recording medium. The image forming unit forms an image on the recording medium held on the surface of the endless device by the attraction force applied by the attracting unit.

### CROSS-REFERENCE TO RELATED APPLICATIONS

This application is based upon and claims the benefit of priority from U.S. Provisional Application No. 61/359,149, filed on Jun. 28, 2010; and U.S. Provisional Application No. 61/384,040, filed on Sep. 17, 2010; the entire contents of which are incorporated herein by reference.

### FIELD

Embodiments described herein relate generally to an image forming apparatus and an image forming method.

### BACKGROUND

In the past, there is an image forming apparatus including a mechanism for holding, with electrostatic force or negative pressure, a recording medium such as paper on the surface of a drum functioning as a holding member. For example, some image forming apparatus such as an inkjet printer forms an image on a recording medium attracted to the surface of a drum. In the image forming apparatus of this type, in order to form a stable image on the recording medium, it is necessary to surely attract the recording medium on the surface of the drum.

### BRIEF DESCRIPTION OF THE DRAWINGS

FIG. 1 is a schematic diagram of a configuration example of an image forming apparatus;

FIG. 2 is a diagram of a state in which a sheet is conveyed from a registration roller pair to a drum;

FIG. 3 is a diagram of a configuration example of a control system in the image forming apparatus;

FIG. 4 is an example of a table in which the magnitudes of pressing force applied to the registration roller pair and various printing conditions are associated with each other;

FIG. 5 is a flowchart for explaining a first processing example; and

FIG. 6 is a flowchart for explaining a second processing example.

### DETAILED DESCRIPTION

In general, according to one embodiment, an image forming apparatus includes a curl forming unit, an endless device, an attracting unit, and an image forming unit. The curl forming unit forms a curl in a recording medium. The endless device holds the recording medium in which the curl is formed by the curl forming unit. The attracting unit applies attraction force for attraction to the surface of the endless device to the recording medium. The image forming unit forms an image on the recording medium held on the surface of the endless device by the attraction force applied by the attracting unit.

An embodiment is explained in detail below with reference to the accompanying drawings.

An image forming apparatus according to this embodiment includes a recording-medium holding device configured to hold a sheet serving as a recording medium. The image forming apparatus according to this embodiment forms an image on the recording medium held by the recording-medium holding device. This embodiment can be applied to any image forming apparatus as long as the image forming apparatus includes a mechanism for holding a recording medium. For example, this embodiment can be applied to printers of various image forming types such as a printer of an inkjet type, a printer of an electrophotographic type, and a printer of a thermal transfer type.

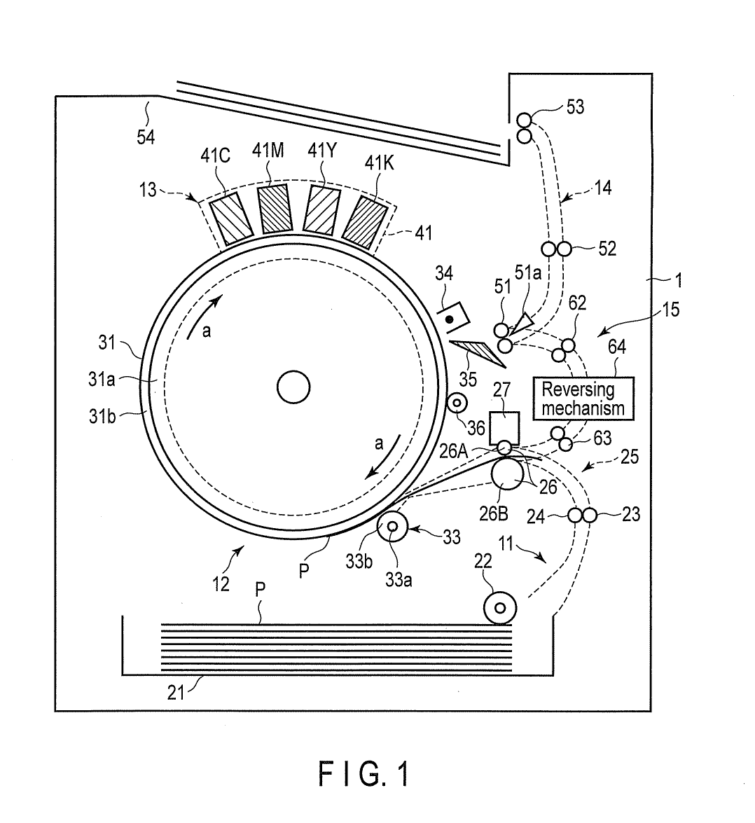

FIG. 1 is a schematic diagram of a configuration example of an image forming apparatus 1 according to this embodiment.

The image forming apparatus 1 shown in FIG. 1 is a printer of the inkjet type (an inkjet printer). As shown in FIG. 1, the image forming apparatus 1 includes a paper feeding unit 11, a sheet holding unit 12, an image forming unit 13, a paper discharge unit 14, and a reversing unit 15. The paper feeding unit 11 feeds a sheet serving as a recording medium to the sheet holding unit 12. The sheet holding unit 12 holds the fed sheet serving as the recording medium in a state in which image formation by the image forming unit 13 is possible. The image forming unit 13 forms an image on the sheet held by the sheet holding unit 12. The paper discharge unit 14 discharges the sheet on which the image is formed by the image forming unit 13.

The paper feeding unit 11 includes a paper feeding cassette 21, a pickup roller 22, a paper feeding roller 23, a separating roller 24, a sheet conveying path 25, and a registration roller pair 26. The paper feeding cassette 21 stores plural sheets. The pickup roller 22 picks up the sheets from the paper feeding cassette 21. The paper feeding roller 23 and the separating roller 24 separate the sheets picked up by the pickup roller 22 one by one. The paper feeding roller 23 and the separating roller 24 feed the separated one sheet P to the sheet conveying path 25. The sheet conveying path 25 guides the sheet P, which is conveyed by the paper feeding roller 23 and the separating roller 24, to the registration roller pair 26.

The registration roller pair 26 delivers the sheet P at desired timing. The registration roller pair 26 corrects a skew of the sheet P. Specifically, the registration roller pair 26 corrects the skew of the sheet P and delivers, at desired timing, the sheet P, the skew of which is corrected, to a drum 31 functioning as a holding member for a recording medium in the sheet holding unit 12. The drum 31 may be an endless device on a belt.

The registration roller pair 26 includes a hard roller 26A and a soft roller 26B. The hard roller 26A and the soft roller 26B are pressed against each other by a pressing mechanism (a pressurizing mechanism) 27. The soft roller 26B is deformed according to the shape of the hard roller 26A pressed by pressing force applied from the pressing mechanism 27. The sheet P passes through a nip between the hard roller 26A and the soft roller 26B deformed by pressing force applied from the pressing mechanism 27. In the nip, the hard roller 26A and the soft roller 26B form a curl to the hard roller 26A side in the sheet P. In other words, the registration roller pair 26 delivers the sheet P to the sheet holding unit 12 while forming a curl in the sheet P.

The sheet holding unit 12 functions as a recording-medium holding device. The sheet holding unit 12 includes a drum 31, a charging roller 33, a charge remover 34, a peeling member 35, and a cleaning member 36. In the sheet holding unit 12, the charging roller 33, the charge remover 34, the peeling member 35, and the cleaning member 36 are set in order in positions opposed to the surface of the drum 31 functioning as the holding member for the sheet P.

The drum 31 is a holding member configured to hold the sheet P serving as the recording medium. In the configuration shown in FIG. 1, the drum 31 has a cylindrical shape. The drum 31 rotates in an “a” direction shown in FIG. 1 around the axis of the cylindrical shape. The drum 31 may be a drum, a unit of which perpendicular to a rotating direction of the drum 31 is flat. The drum 31 includes a cylindrical frame 31a formed of a conductor and a dielectric 31b on the surface of the frame 31a.

For example, in the drum 31 having the configuration example shown in FIG. 1, the frame 31a is formed of a conductor of metal such as aluminum. The dielectric 31b is formed as a thin layer on the surface of the cylindrical frame 31a formed of the conductor. The potential of the frame 31a is set to 0 [v] by grounding the inner side of the frame 31a. The potential of the inner side of the frame 31a functioning as a counter electrode opposed to the charging roller 33 is maintained at 0 [v].

The charging roller 33 includes a cored bar 33a extending along the axis of a rotation axis of the charging roller 33 and a cylindrical conductive member 33b provided on the outer side of the cored bar 33a. Voltage is applied to the cored bar 33a of the charging roller 33. The charging roller 33 rotates according to the rotation of the drum 31 in a state in which the cylindrical conductive member 33b is in contact with the surface of the drum 31. The charging roller 33 is pressed against the surface of the drum 31. The sheet P, in which a curl in a direction along the surface of the drum 31 is formed, is fed to a nip between the charging roller 33 and the drum 31 from the registration roller pair 26.

If the sheet P rushes into the nip between the charging roller 33 and the drum 31, a high voltage is applied to the cored bar 33a of the charging roller 33. Since the inner side of the drum 31 is grounded, a potential difference corresponding to the potential applied to the charging roller 33 is applied to the nip between the charging roller 33 and the drum 31. In other words, in the nip between the charging roller 33 and the drum 31, the charging roller 33 charges, with the voltage applied to the cored bar 33a, the sheet P adhering to the surface of the drum 31.

The sheet P charged by the charging roller 33 is attracted to the surface of the drum 31 by electrostatic force. In other words, the charging roller 33 functions as an attracting-force supplying unit (an attracting unit) configured to supply attraction force for attraction to the drum 31 to the sheet P. The drum 31 rotates with the sheet P attracted to (held on) the surface of the drum 31. The sheet P attracted to the surface of the drum 31 moves to an image forming position for image formation by the image forming unit 13 according to the rotation of the drum 31.

The drum 31 may attract the sheet P through negative pressure attraction. In this case, as an attraction-force supplying unit, a negative pressure mechanism configured to supply negative pressure, which is applied to the inner side of the drum 31, to the sheet P on the surface of the drum 31 is provided instead of the charging roller configured to supply chargers to the sheet P. In the case of a configuration for attracting the sheet P to the drum 31 through the negative pressure attraction, a component such as a charge remover is unnecessary.

The image forming unit 13 includes a printing head group 41 including plural printing heads 41C, 41M, 41Y, and 41K. The printing heads 41 are set opposed to the surface of the drum 31. The printing head 41C ejects cyan ink. The printing head 41M ejects magenta ink. The printing head 41Y ejects yellow ink. The printing head 41K ejects black ink.

The printing heads 41 form, by ejecting the inks on the basis of image information, an image on the surface of the sheet P attracted to the surface of the drum 31. The drum 31 rotates by the number of revolutions corresponding to a printing condition with the sheet P attracted to the surface. The drum 31 can moves the sheet P attracted to the surface to the image forming position the number of times same as the number of revolutions of the drum 31. In other words, the printing heads 41 of the image forming unit 13 can repeatedly execute image formation on the sheet P the number of times same as the number of revolutions of the drum 31.

For example, in the case of a configuration for forming an image of one color in one rotation of the drum 31, a full-color image can be completed by forming images respectively with inks of four colors (cyan, magenta, yellow, and black), which form a full color, on a sheet that rotates four times together with the drum 31. If an image is formed at resolution higher than physical resolution of the printing heads 41, an image having high resolution can be formed by forming images plural times on a sheet that rotates plural times together with the drum 31. If an image is formed at high density, a high-density image can be formed by forming images plural times on a sheet that rotates plural times together with the drum 31.

If a sheet attracted to the drum 31 is rotated two or more times to execute image formation plural times, the peeling member 35, the cleaning member 36, and the charging roller 33 may be separated from the surface of the drum 31 by separating mechanisms respectively provided in the peeling member 35, the cleaning member 36, and the charging roller 33. In other words, in a period until an image is completed after the sheet P is attracted to the surface of the drum 31, the peeling member 35, the cleaning member 36, and the charging roller 33 can be prevented from coming into contact with the surface of the sheet P, on which an image is being formed, by separating the peeling member 35, the cleaning member 36, and the charging roller 33 from the surface of the drum 31.

The sheet P, on which an image is formed by the image forming unit 13, is peeled off the surface of the drum 31 after being subjected to charge removal and is delivered to a conveying roller 51. If the image formation on the surface of the sheet P by the image forming unit 13 is completed, the charge remover 34 removes charges of the sheet P. The peeling member 35 peels the sheet P off the surface of the drum 31.

The charge remover 34 removes charges from a sheet attracted to the surface of the drum 31. The charge remover 34 removes charges in no contact with the surface of the drum 31 and the sheet P. For example, the charge remover 34 applies, with a corona discharger, AC potential to the sheet P attracted to the surface of the drum 31. The charge remover 34 eliminates, by applying AC potential to the drum 31 and the sheet P, electrostatic attraction force applied to the sheet P by the drum 31.

The peeling member 35 peels the sheet P off the surface of the drum 31. The peeling member 35 is brought into contact with the surface of the drum 31 before the leading end of the sheet P to be peeled reaches a peeling position. In a state in which the peeling member 35 is in contact with the surface of the drum 31, the peeling member 35 separates the sheet P, on which image formation is completed, from the surface of the drum 31. The peeling member 35 guides the sheet P peeled off the surface of the drum 31 to the conveying roller 51.

The cleaning member 36 is set between the peeling member 35 and the charging roller 33. The cleaning member 36 cleans the surface of the drum 31. The cleaning member 36 is pressed against the surface of the drum 31 after the sheet P is peeled off. The drum 31 rotates in a state in which the cleaning member 36 is pressed against the surface of the drum 31, whereby the cleaning member 36 cleans the surface of the drum 31.

The paper discharge unit 14 includes plural conveying rollers 51, 52, and 53 and a paper discharge table 54. The sheet P peeled off the surface of the drum 31 by the peeling member 35 is fed to the conveying roller 51. The paper discharge unit 14 shares the conveying roller 51 with the reversing unit 15. The sheet P fed from the peeling position of the drum 31 to the conveying roller 51 is selectively conveyed to the paper discharge unit 14 or the reversing unit 15 by a diverting mechanism 51a. The conveying roller 51 delivers the sheet P, which is guided to the paper discharge unit 14 by the diverting mechanism 51a, to the conveying roller 52. The conveying roller 52 delivers the sheet P, which is fed from the conveying roller 51, to the conveying roller 53. The conveying roller 53 discharges the sheet P, which is fed from the conveying roller 52, to the paper discharge table 54.

The reversing unit 15 includes plural conveying rollers 51, 62, and 63 and a reversing mechanism 64. The conveying roller 51 delivers, among sheets fed from the peeling position of the drum 31, the sheet P, which is guided to the reversing unit 15 by the diverting mechanism 51a, to the conveying roller 62. The conveying roller 62 delivers the sheet P, which is fed from the conveying roller 51, to the reversing mechanism 64. The reversing mechanism 64 delivers the reversed sheet P to the conveying roller 63. The conveying roller 63 feeds the reversed sheet P to the registration roller pair 26. The reversing unit 15 reverses the sheet P such that printing on the rear surface of the sheet P, on a first surface of which an image is formed, can be performed and feeds the sheet P to the registration roller pair 26 again (reversely feeds the sheet P).

The configuration and actions of the registration roller pair 26 are explained below.

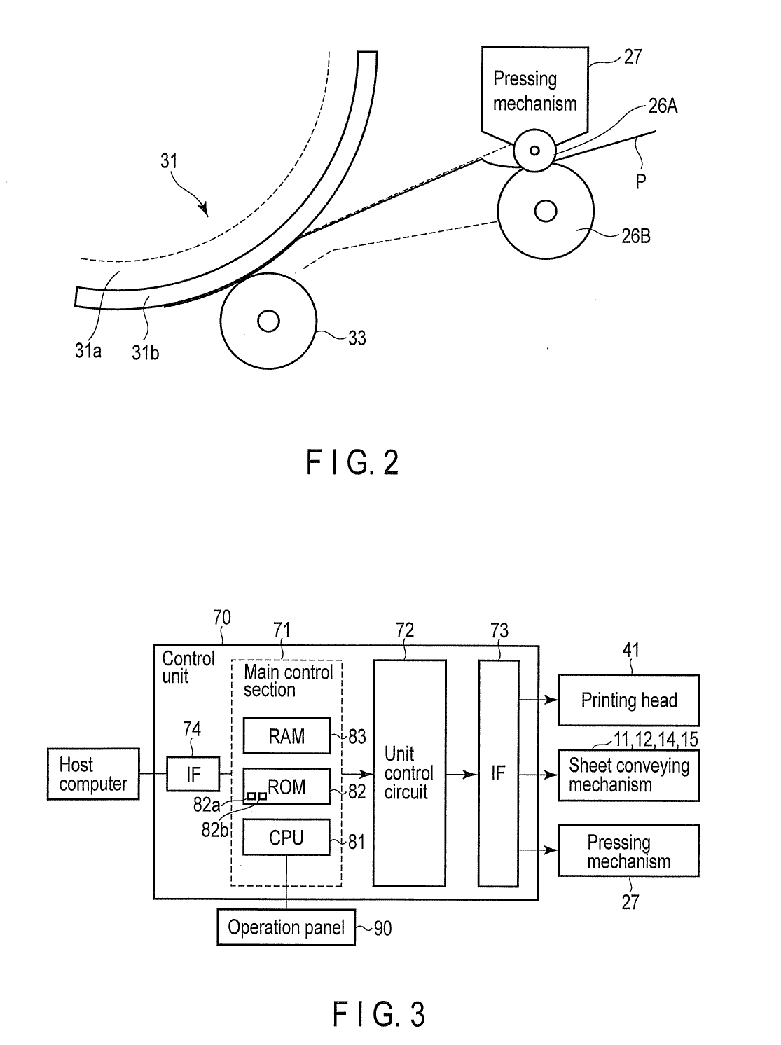

FIG. 2 is a diagram of a state in which the sheet P rushes into the drum 31 from a nip of the registration roller pair 26.

The registration roller pair 26 includes both a function of delivering the sheet P, a skew of which is corrected, at desired timing and a function of a curl roller configured to curl the sheet P to the drum 31 side. The registration roller pair 26 has a configuration in which the hard roller 26A and the soft roller 26B are combined. The hard roller 26A and the soft roller 26B are cylindrical rollers. The hard roller 26A is a roller having a diameter smaller than the diameter of the soft roller 26B. The outer circumferential surfaces of the hard roller 26A and the soft roller 26B are pressed against each other by force applied from the pressing mechanism 27.

The hard roller 26A is formed of a hard material, which is less easily deformed, such as metal or resin. The hard roller 26A is a roller, the shape of which is less easily deformed. The soft roller 26B is formed of a soft and elastic material such as rubber or sponge. The soft roller 26B is a roller having resilience, the shape of which is less easily deformed.

The hard roller 26A and the soft roller 26B have strengths different from each other. Therefore, in the nip between the hard roller 26A and the soft roller 26B, the hard roller 26A cuts into the soft roller 26B according to the magnitude of pressing force (a pressing amount). The sheet P passing through the nip, in which the hard roller 26A cuts into the soft roller 26B, is rectified by the surface shape of the hard roller 26A. As a result, the registration roller pair 26 can form a curl on the hard roller 26A side in the sheet P. The registration roller pair 26 can apply pressure to the sheet P in the nip between the hard roller 26A and the soft roller 26B. Therefore, there is also an effect that the registration roller pair 26 smoothes unevenness such as creases in the sheet P.

The hard roller 26A and the soft roller 26B included in the registration roller pair 26 are pressed against each other by pressure (pressing force) applied from the pressing mechanism 27. In an example shown in FIG. 2, the pressing mechanism 27 is configured to apply force for pressing against the soft roller 26B to the hard roller 26A. The pressing mechanism 27 can adjust force (the magnitude of the pressing force) for pressing the hard roller 26A against the soft roller 26B.

For example, as the pressing force from the pressing mechanism 27 is larger, the hard roller 26A cuts into the soft roller 26B more deeply. Therefore, as the pressing force from the pressing mechanism 27 is larger, the nip between the hard roller 26A and the soft roller 26B forms a curl having a larger curl amount. In other words, the strength (a curl amount) of a curl formed by the registration roller pair 26 can be controlled by controlling the magnitude of the pressing force applied by the pressing mechanism 27.

The pressing mechanism 27 changes a pressing amount according to a state of a sheet, a peripheral environment state, or the like. For example, the pressing mechanism 27 changes pressing force (a pressing amount) according to the thickness of a sheet, printing speed, or humidity in the apparatus (or around the apparatus). In the case of rear surface printing on the sheet P, the pressing mechanism 27 may change the pressing force according to a printing ratio, a color, resolution, or the like on the sheet P. In this embodiment, the pressing mechanism 27 adjusts the magnitude of the pressing force (i.e., a curl amount) according to a control amount determined by a control unit explained later.

The pressing mechanism 27 can adjust not only the magnitude of the pressing force but also timing and time if the hard roller 26A is pressed against the soft roller 26B. For example, the pressing mechanism 27 forms, by controlling pressing force applied to the hard roller 26A and the soft roller 26B according to conveyance timing for the sheet P, a curl in a part of the sheet P passing through the nip between the hard roller 26A and the soft roller 26B.

For example, the pressing mechanism 27 can form, by applying pressing force having magnitude enough for forming a curl to the sheet P at timing if the distal end portion of the sheet P passes the nip between the hard roller 26A and the soft roller 26B, a curl in the distal end portion of the sheet P passing through the registration roller pair 26.

The pressing mechanism 27 can form, by applying pressing force having magnitude enough for forming a curl to the sheet P at timing if the trailing end portion of the sheet P passes the nip between the hard roller 26A and the soft roller 26B, a curl in the trailing end portion of the sheet P passing through the registration roller pair 26.

The pressing mechanism 27 can control, by controlling time if pressing force having magnitude enough for forming a curl is applied to the sheet P, an area (length in a conveying direction) of a region where a curl is formed in the sheet P.

The configuration of a control system in the image forming apparatus 1 is explained below.

FIG. 3 is a diagram of a configuration example of the control system in the image forming apparatus 1.

As shown in FIG. 3, the image forming apparatus 1 includes a control unit 70. The control unit 70 controls the units of the image forming apparatus 1. The control unit 70 includes a main controller 71, a unit control circuit 72, an internal interface 73, and an external interface 74.

The main controller 71 includes a CPU 81, a ROM 82, and a RAM 83. The CPU 81 is a processor configured to execute control of the units, data processing, and the like. The ROM 82 has stored therein a control program, a control data, and the like. The RAM 83 temporarily stores data. In the main controller 71, the CPU 81 executes, using the RAM 83 functioning as a working memory, the control program stored in the ROM 82 to thereby execute various kinds of control and data processing.

The ROM 82 has stored therein information for the CPU 81 to determine pressing force applied to the registration roller pair (a curl roller) 26 by the pressing mechanism 27, control timing, and the like. For example, the ROM 82 has stored therein a table 82a in which pressing force applied to the registration roller pair 26 (the strength and a curl amount of a curl formed in a sheet) is stored in association with various printing conditions and a table 82b in which timing for applying pressing force to the registration roller pair 26 (a position where a curl is formed) is stored in association with various printing conditions.

For example, in the table 82b, information indicating an area for formation of a curl is stored in association with the size or the thickness of a sheet as a printing condition. In the table 82b, setting information indicating that, as the size of a sheet is larger, the area for formation of a curl is larger is stored. In the table 82b, setting information indicating that, as the thickness of a sheet is larger, the area for formation of a curl is larger is stored. An example of the table 82a is explained later.

The unit control circuit 72 is a control circuit for causing the units to operate according to a control command from the main controller 71. The internal interface 73 is an interface for connecting the unit control circuit 72 and the units in the image forming apparatus 1. For example, the internal interface 73 is connected to the printing heads 41, the sheet conveying mechanisms 11, 12, 14, and 15, and the pressing mechanism 27.

An operation panel 90 is connected to the main controller 71. The operation panel 90 is a user interface for a user to input an operation instruction such as printing conditions. For example, the operation panel 90 includes hard keys and a display device incorporating a touch panel. On the operation panel 90, selection of duplex or simplex, a type (e.g., size and thickness) of the sheet P, humidity in the apparatus (or around the apparatus), a state (e.g., a printing ratio, resolution, and a color) of an image formed on the sheet P, and the like are input as printing conditions.

An external apparatus such as a host computer may be connected to the main controller 71 via the external interface 74.

The strength of a curl formed in a sheet according to printing conditions is explained below.

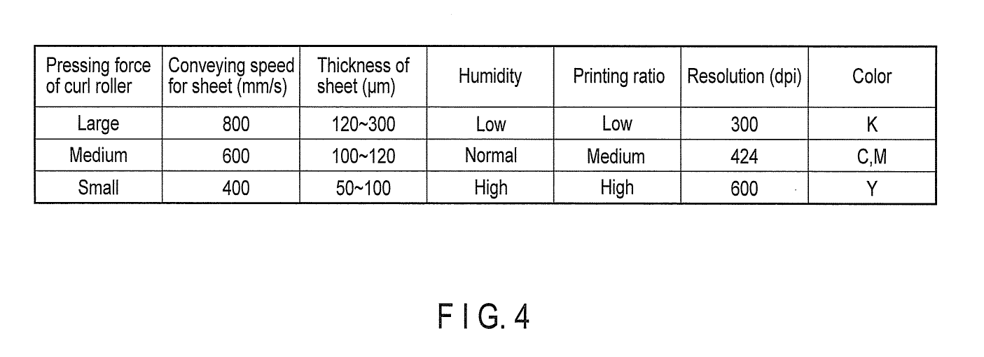

FIG. 4 is an example of the table 82a in which the magnitude of pressing force applied to the registration roller pair 26 and various printing conditions are associated. The magnitude of the pressing force applied to the registration roller pair 26 by the pressing mechanism 27 indicates the strength of a curl formed in a sheet. In other words, the table 82a indicates the strength of a curl that should be set for various printing conditions.

In the example of the table 82a shown in FIG. 4, setting information indicating that, as conveying speed for the sheet P is higher, pressing force is set larger is stored. According to the setting example shown in FIG. 4, the CPU 81 sets pressing force indicated to the pressing mechanism 27 larger as the conveying speed for the sheet P is higher.

According to the setting example shown in FIG. 4, the CPU 81 sets pressing force indicated to the pressing mechanism 27 larger as the thickness of the sheet P is larger. For example, the CPU 81 determines the thickness of the sheet P according to a type of a sheet selected on the operation panel 90. In the image forming apparatus 1, a thickness detection sensor configured to detect the thickness of the sheet P may be provided in a unit from paper feed to the registration roller pair 26. In this case, the CPU 81 determines, on the basis of thickness information detected by the thickness detection sensor, pressing force applied to the registration roller pair 26.

According to the setting example shown in FIG. 4, the CPU 81 sets pressing force indicated to the pressing mechanism 27 larger as humidity (in the apparatus or around the apparatus) is lower. For example, the CPU 81 determines humidity according to humidity information input by the user on the operation panel 90. In the image forming apparatus 1, a humidity sensor configured to measure humidity in the apparatus or around the apparatus may be set. In this case, the CPU 81 determines, on the basis of humidity detected by the humidity sensor, pressing force applied to the registration roller pair 26.

In the setting example shown in FIG. 4, a printing ratio, resolution, and a color are conditions for an image already formed on a first surface in a sheet, on a second surface (the rear surface) of which an image is formed in duplex printing. In other words, the printing ratio, the resolution, and the color indicate a printing ratio, resolution, and a color of the image already formed on the first surface of the sheet P. These kinds of information are information input to the operation panel 90 before the duplex printing is started. The CPU 81 acquires printing conditions such as a printing ratio, resolution, and a color from the operation panel 90.

According to the example shown in FIG. 4, the CPU 81 sets pressing force indicated to the pressing mechanism 27 larger as a printing ratio of an image formed on the rear surface of the sheet P is lower. The CPU 81 sets pressing force indicated to the pressing mechanism 27 larger as the resolution of the image formed on the rear surface of the sheet P is higher. The CPU 81 sets pressing force indicated to the pressing mechanism 27 larger in order of colors yellow (Y), cyan (C), magenta (M), and black (K) of the image formed on the rear surface of the sheet P. If an image formed on the first surface of the sheet P is a color image, the CPU 81 may set pressing force indicated to the pressing mechanism 27 larger than pressing force set if an image formed on the first surface of the sheet P is a monochrome image.

As a first processing example in the image forming apparatus 1, processing for controlling, according to printing conditions, the magnitude of pressing force applied to the registration roller pair (the curl roller) 26 is explained below.

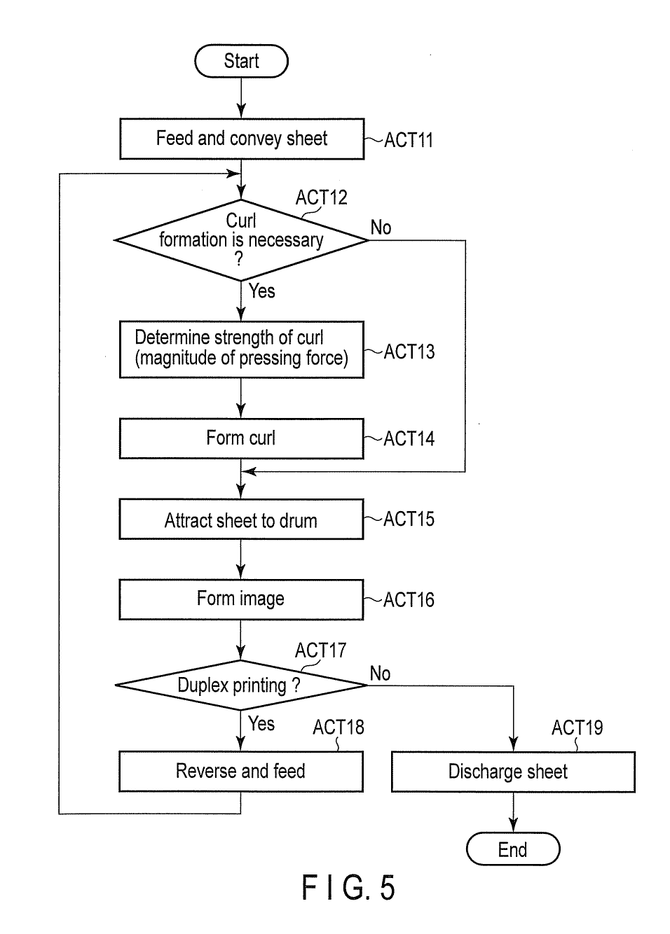

FIG. 5 is a flowchart for explaining the first processing example.

If the user who sets printing conditions on the operation panel 90 instructs the start of printing, the CPU 81 of the main controller 71 feeds a sheet matching the printing conditions with the paper feeding unit 11 and conveys the sheet to the registration roller pair 26 (ACT 11). The CPU 81 determines, on the basis of the printing conditions, whether it is necessary to form, with the registration roller pair 26, a curl in a sheet on which an image is formed (ACT 12).

For example, the CPU 81 determines necessity of curl formation with respect to the printing conditions on the basis of the information stored in the table 82a shown in FIG. 4. The CPU 81 comprehensively determines, on the basis of information of the table 82a indicating the magnitude of pressing force with respect to various setting items included in the printing conditions, whether it is necessary to form a curl with respect to the printing conditions for the sheet. For example, concerning the various setting items of the printing conditions for the sheet, if setting contents in which the pressing force is set as “small” is larger than a predetermined number, the CPU 81 may determine that curl formation is unnecessary.

If the CPU 81 determines that it is unnecessary to form a curl (NO in ACT 12), the CPU 81 performs control to convey the sheet P to the drum 31 without forming a curl in the sheet P. For example, the CPU 81 indicates to the pressing mechanism 27 pressing force having magnitude for not forming a curl in the sheet P conveyed by the registration roller pair 26. The pressing mechanism 27 applies pressing force having magnitude for not forming a curl in the sheet P in the nip of the registration roller pair 26. As a result, the registration roller pair 26 feeds the sheet P to a nip between the drum 31 and the charging roller 33 without forming a curl in the sheet P.

If the CPU 81 determines that it is necessary to form a curl (YES in ACT 12), the CPU 81 determines, as the strength of a curl (a curl amount) that should be applied to the sheet, the magnitude of pressing force applied to the registration roller pair 26 by the pressing mechanism 27 (ACT 13). The CPU 81 determines, on the basis of the information stored in the table 82a shown in FIG. 4, the strength of a curl corresponding to the printing conditions for the sheet (the magnitude of the pressing force applied to the registration roller pair 26 by the pressing mechanism 27). For example, the CPU 81 sets the pressing force large (sets the curl strong) if there are many items of printing conditions in which pressing force should be set large among the printing conditions for the sheet. The CPU 81 sets the pressing force small (sets the curl weak) if there are many items of printing conditions in which pressing force should be set small among the printing conditions for the sheet.

After determining the magnitude of the pressing force applied to the registration roller pair 26, the CPU 81 indicates the determined magnitude of the pressing force to the pressing mechanism 27. The pressing mechanism 27 presses the hard roller 26A against the soft roller 26B with the magnitude of the pressing force indicated by the CPU 81. The registration roller pair 26 forms, in the sheet P passing through the nip of the hard roller 26A and the soft roller 26B, a curl having strength corresponding to the magnitude of the pressing force applied by the pressing mechanism 27 (ACT 14). The nip between the hard roller 26A and the soft roller 26B curls the sheet P to the hard roller 26A side. The registration roller pair 26 conveys the sheet P to the nip between the drum 31 and the charging roller 33 such that the curl formed in the sheet P extends along the surface of the drum 31.

The sheet P curled to the drum 31 side is fed to the nip between the drum 31 and the charging roller 33 from the registration roller pair 26. In the nip between the drum 31 and the charging roller 33, the charging roller 33 applies charges to the sheet P as attraction force for attracting the sheet P to the drum 31. The drum 31 grounded on the inside attracts the sheet P, to which the charges are applied from the charging roller 33, to the surface of the drum 31 with electrostatic force (ACT 15).

The drum 31 that attracts the sheet P rotates at speed corresponding to conveying speed determined according to the printing conditions. The drum 31 carries a printing surface of the sheet P to the image forming position by rotating in a state in which the sheet P is attracted to the surface. The image forming unit 13 forms an image if the sheet P attracted to the surface of the drum 31 passes a position corresponding to the printing head 41 (ACT 16). Specifically, in the image forming unit 13, the printing head 41 forms an image on the sheet P attracted to the surface of the drum 31 by ejecting ink according to image information of the image to be printed. In the image forming unit 13, the printing head 41 may form an image on the printing surface of the sheet P by the rotation of the drum 31 plural times while the state in which the drum 31 attracts the sheet P is kept.

If the image formation on the first surface (the front surface) is completed, after removing charges of the sheet P with the charge remover 34, the CPU 81 peels the sheet P off the surface of the drum 31 with the peeling member 35 in the peeling position and guides the sheet P to the conveying roller 51. The CPU 81 diverts, with a diverting mechanism 30, the sheet P delivered by the conveying roller 51 to the reversing unit 15 or the paper discharge unit 14.

In the case of simplex printing (NO in ACT 17), the CPU 81 guides the sheet P, on the first surface of which the image formation is completed, to the paper discharge unit 14 with the diverting mechanism 30. The paper discharge unit 14 guides the sheet P, which is delivered by the conveying roller 51, to the conveying roller 52 with the diverting mechanism 30 and discharges the sheet P to the paper discharge table 54 with the conveying rollers 52 and 53 (ACT 19).

In the case of duplex printing (YES in ACT 17), the CPU 81 guides the sheet P, on the first surface of which the image formation is completed, to the reversing unit 15 with the diverting mechanism 30. In other words, if an image is formed on the second surface (the rear surface) of the sheet P, on the first surface of which the image formation is completed, the CPU 81 guides the sheet P, which is delivered by the conveying roller 51, to the reversing unit 15 with the diverting mechanism 30. The reversing unit 15 conveys the sheet P in a state in which the sheet P is reversed by the conveying rollers 62 and 63 and the reversing mechanism 64 and feeds the sheet P to the registration roller pair 26 again (reversely feeds the sheet P) (ACT 18).

The CPU 81 executes the processing from ACT 12 on the sheet P reversely fed to the registration roller pair 26. Specifically, the CPU 81 determines whether it is necessary to form a curl in the reversely-fed sheet P (ACT 12). If it is necessary to form a curl in the reversely-fed sheet P (YES in ACT 12), the CPU 81 determines the strength of a curl (the magnitude of the pressing force) according to the printing conditions (ACT 13). In this case, the CPU 81 determines the strength of a curl (the magnitude of the pressing force) corresponding to the printing conditions including a printing ratio, resolution, a color, and the like of the image printed on the first surface.

After determining the strength of the curl (the magnitude of the pressing force), the CPU 81 forms a curl in the sheet P with the registration roller pair 26 pressed against the sheet P with the determined pressing force (ACT 14). The CPU 81 causes the registration roller pair 26 to convey the sheet P, in which the curl is formed, to the drum 31. The drum 31 rotates in a state in which the sheet P charged by the charging roller 33 is attracted to the surface (ACT 15). The printing head 41 of the image forming unit 13 forms an image on the sheet P attracted to the rotating drum 31 (ACT 16).

If the image formation on the second surface (the rear surface) is completed, i.e., if the duplex printing is completed (NO in ACT 17), after removing charges of the sheet P with the charge remover 34, the CPU 81 peels the sheet P off the surface of the drum 31 with the peeling member 35 in the peeling position and guides the sheet P to the conveying roller 51. The conveying roller 51 delivers the sheet P guided to the paper discharge unit 14 by the diverting mechanism 30. The CPU 81 discharges the sheet P, which is guided to the paper discharge unit 14, to the paper discharge table 54 with the conveying rollers 52 and 53 (ACT 19).

In the first processing example, the strength of a curl formed in a sheet is determined according to printing conditions such as the thickness of the sheet. The registration roller pair 26 pressed with pressing force having magnitude corresponding to the strength of the curl forms a curl on a drum side in the sheet and feeds the sheet, in which the curl is formed, to the surface of the drum.

According to the first processing example, it is possible to make it easy for the sheet adhere to the surface of the drum with the curl formed in the sheet according to the printing conditions such as the thickness of the sheet and improve adhesion to the drum. Further, since a curl having strength corresponding to the printing conditions such as the thickness of the sheet is formed, it is possible to realize stable adhesion to the drum even under various printing conditions.

As a second processing example in the image forming apparatus 1, control for partially curling the sheet P is explained below.

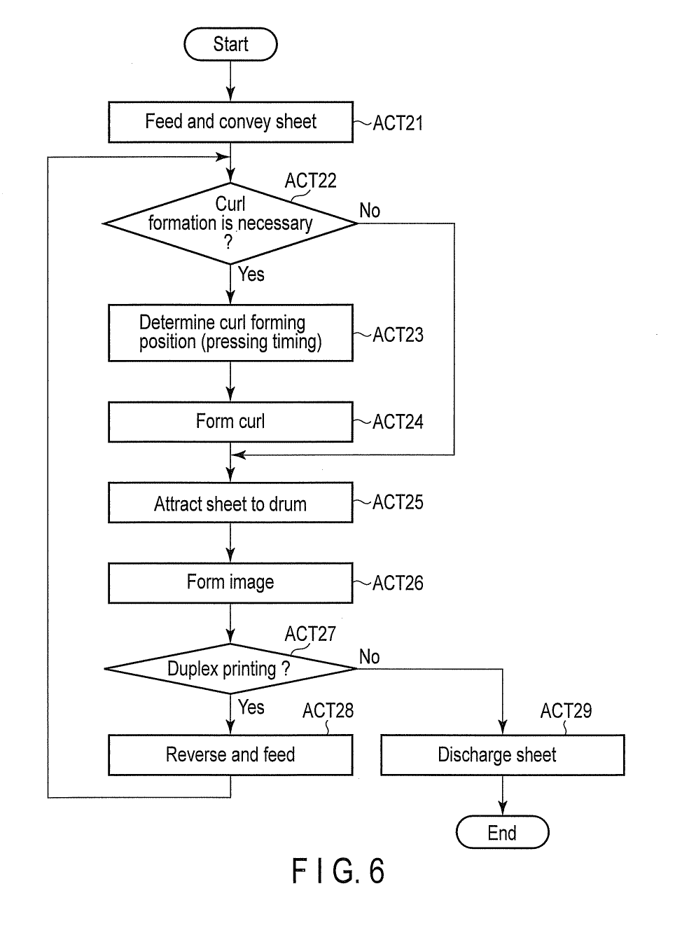

FIG. 6 is a flowchart for explaining the second processing example.

If the user who sets printing conditions on the operation panel 90 instructs the start of printing, the CPU 81 of the main controller 71 feeds a sheet matching the printing conditions with the paper feeding unit 11 and conveys the sheet to the registration roller pair 26 (ACT 21). The CPU 81 determines, on the basis of the printing conditions, whether it is necessary to form, with the registration roller pair 26, a curl in a sheet on which an image is formed (ACT 22). For example, the CPU 81 determines necessity of curl formation on the basis of information indicating a curl forming position associated with the various setting items included in the printing conditions stored in the table 82b. The CPU 81 may determine necessity of a curl according to the information stored in the table 82a shown in FIG. 4.

If the CPU 81 determines that it is unnecessary to form a curl (NO in ACT 22), the CPU 81 performs control to convey the sheet P to the drum 31 without forming a curl in the sheet P. For example, the CPU 81 indicates to the pressing mechanism 27 pressing force having magnitude for not forming a curl in the sheet P. The pressing mechanism 27 applies the pressing force having the magnitude for not forming a curl in the sheet P in the nip of the registration roller pair 26. The registration roller pair 26 feeds the sheet P to a nip between the drum 31 and the charging roller 33 without forming a curl in the sheet P.

If the CPU 81 determines that it is necessary to form a curl (YES in ACT 22), the CPU 81 determines a position where a curl is formed in the sheet P (Act 23). For example, as default setting of the curl forming position, the CPU 81 forms curls at the leading end portion and the trailing end portion of the sheet P. In the table 82b, information for determining a curl forming position corresponding to printing conditions may be stored. In this case, the CPU 81 determines a curl forming position corresponding to printing conditions on the basis of the information stored in the table 82b.

The CPU 81 may determine a size (an area) of formation of a curl according to printing conditions such as the size of a sheet or the thickness of the sheet. In this case, in the table 82b, a size (an area) of formation of a curl is stored in association with the printing conditions. The CPU 81 can determine a size (an area) of a curl forming position corresponding to the printing conditions according to the information stored in the table 82b.

The registration roller pair 26 forms a curl in the sheet P conveyed at conveying speed corresponding to the printing conditions (ACT 24). The CPU 81 controls, by controlling the pressing mechanism 27 according to the curl forming position on the sheet P and the size of the curl forming position, the position of the curl formed on the sheet P by the registration roller pair 26. Specifically, the CPU 81 controls the position and the size of curl formation with time (timing) if pressing force for forming a curl in the sheet P being conveyed is applied to the registration roller pair 26 by the pressing mechanism 27. The registration roller pair 26 curls a part of the sheet P to the hard roller 26A side and conveys the sheet P to the nip between the drum 31 and the charging roller 33 such that the curl in the sheet P extends along the surface of the drum 31.

The sheet P curled to the drum 31 side is fed to the nip between the drum 31 and the charging roller 33 from the registration roller pair 26. In the nip between the drum 31 and the charging roller 33, the charging roller 33 applies charges to the sheet P as attraction force for attracting the sheet P to the drum 31. The sheet P charged by the charging roller 33 is attracted to the surface of the drum 31 grounded on the inside by electrostatic force (ACT 25).

The drum 31 that attracts the sheet P rotates at speed corresponding to conveying speed determined according to the printing conditions. The drum 31 carries the printing surface of the sheet P to the image forming position by rotating in a state in which the sheet P is attracted to the surface. The image forming unit 13 forms an image if the sheet P attracted to the surface of the drum 31 passes a position corresponding to the printing head 41 (ACT 26). Specifically, in the image forming unit 13, the printing head 41 forms an image on the sheet P by ejecting, according to image information of the image to be printed, ink to the sheet P attracted to the surface of the drum 31. In the image forming unit 13, the printing head 41 may form an image on the printing surface of the sheet P by the rotation of the drum 31 plural times while the state in which the drum 31 attracts the sheet P is kept.

If the image formation on the first surface (the front surface) is completed, after removing charges of the sheet P with the charge remover 34, the CPU 81 peels the sheet P off the surface of the drum 31 with the peeling member 35 in the peeling position and guides the sheet to the conveying roller 51. The CPU 81 diverts, with the diverting mechanism 30, the sheet P delivered by the conveying roller 51 to the reversing unit 15 or the paper discharge unit 14.

In the case of simplex printing (NO in ACT 27), the CPU 81 guides the sheet P, on the first surface of which the image formation is completed, to the paper discharge unit 14 with the diverting mechanism 30. The paper discharge unit 14 guides the sheet P, which is delivered by the conveying roller 51, to the conveying roller 52 with the diverting mechanism 30 and discharges the sheet P to the paper discharge table 54 with the conveying rollers 52 and 53 (ACT 29).

In the case of duplex printing (YES in ACT 27), the CPU 81 guides the sheet P, on the first surface of which the image formation is completed, to the reversing unit 15 with the diverting mechanism 30. In other words, if an image is formed on the second surface (the rear surface) of the sheet P, the CPU 81 guides the sheet P, which is delivered by the conveying roller 51, to the reversing unit 15 with the diverting mechanism 30. The reversing unit 15 conveys the sheet P in a state in which the sheet P is reversed by the conveying rollers 62 and 63 and the reversing mechanism 64 and feeds the sheet P to the registration roller pair 26 again (reversely feeds the sheet P) (ACT 28).

The CPU 81 executes the processing from ACT 22 on the sheet P reversely fed to the registration roller pair 26. Specifically, the CPU 81 determines whether it is necessary to form a curl in the reversely-fed sheet P (ACT 22). If it is necessary to form a curl in the reversely-fed sheet P (YES in ACT 22), the CPU 81 determines a curl forming position according to the printing conditions or the like (ACT 23). For example, the CPU 81 may determine a curl forming position according to printing conditions including a printing ratio, resolution, a color, and the like of the image printed on the first surface.

After determining the curl forming position, the CPU 81 controls the pressing mechanism 27 to form a curl in the curl forming position in the sheet P (ACT 24). The CPU 81 causes the registration roller pair 26 to convey the sheet P, in which the curl is formed, to the drum 31. The drum 31 rotates in a state in which the sheet P charged by the charging roller 33 is attracted to the surface (ACT 25). An image is formed on the sheet P, which is attracted to the rotating drum 31, by the printing head 41 of the image forming unit 13 (ACT 26).

If the image formation on the second surface (the rear surface) is completed, i.e., if the duplex printing is completed (NO in ACT 27), after charges of the sheet P are removed by the charge remover 34, the sheet P is peeled off the surface of the drum 31 by the peeling member 35 in the peeling position and guided to the conveying roller 51. The conveying roller 51 delivers the sheet P to guide it to the paper discharge unit 14 by the diverting mechanism 30. The sheet P guided to the paper discharge unit 14 is discharged to the paper discharge table 54 by the conveying rollers 52 and 53 (ACT 29).

In the second processing example, a curl is formed in a part of a sheet such as the leading end portion or the trailing end portion. According to the second processing example, it is possible to make it easy for the sheet adhere to the surface of the drum and improve attraction to the drum by curling only a part of the sheet such as the leading end or the trailing end. It is possible to reduce, for example, occurrence of a jam in a conveying process (peeling, decurling, roller conveyance, etc.) for the sheet after the curl formation by forming the curl only in a part of the sheet.

In the second processing example, it is possible to realize stable attraction to the drum according to printing conditions and reduce a jam in the conveying process after the curl formation by changing an area for formation of a curl according to printing conditions such as the thickness of the sheet or the size of the sheet.

The first processing example and the second processing example can be carried out in combination. Specifically, the image forming apparatus 1 can also form, with the registration roller pair 26 (strength of a curl) pressed with pressing force having magnitude determined according to printing conditions, a curl in a part of a sheet such as the leading end portion or the trailing end portion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a curl forming unit which forms a curl in a recording medium;
an endless device which holds the recording medium in which the curl is formed by the curl forming unit;
an attracting unit which applies attraction force for attraction to a surface of the endless device to the recording medium; and
an image forming unit which forms an image on the recording medium held on the surface of the endless device by the attraction force applied by the attracting unit.

2. The apparatus according to claim 1, wherein the curl forming unit forms a curl corresponding to a printing condition on the recording medium.

3. The apparatus according to claim 1, wherein the curl forming unit includes a hard roller and a soft roller and forms a curl in the recording medium in a nip formed by pressing the hard roller and the soft roller against each other.

4. The apparatus according to claim 3, wherein the curl forming unit has a function of a registration roller that controls timing if the recording medium is conveyed to the endless device.

5. The apparatus according to claim 3, further comprising a pressing mechanism which presses the hard roller and the soft roller against each other with pressing force having magnitude corresponding to the printing condition, wherein
the hard roller and the soft roller form, in the recording medium, a curl having a curl amount corresponding to the magnitude of the pressing force applied by the pressing mechanism.

6. The apparatus according to claim 5, further comprising:
a storing unit which stores magnitudes of pressing force associated with various printing conditions; and
a controller which determines, according to information stored in the storing unit, magnitude of pressing force corresponding to a printing condition to be executed and indicate the determined magnitude of the pressing force to the pressing mechanism, wherein
the pressing mechanism presses the hard roller and the soft roller against each other with the pressing force having the magnitude indicated by the controller.

7. The apparatus according to claim 1, wherein the curl forming unit forms the curl in a part of the recording medium.

8. The apparatus according to claim 7, wherein the curl forming unit forms the curl at a leading end of the recording medium.

9. The apparatus according to claim 7, wherein the curl forming unit forms the curl at a trailing end of the recording medium.

10. The apparatus according to claim 7, wherein the curl forming unit forms the curl at a leading end and a trailing end of the recording medium.

11. An image forming method comprising:
forming a curl in a recording medium;
attracting the recording medium in which the curl is formed to a surface of an endless device; and
forming an image on the recording medium attracted to the surface of the endless device.

12. The method according to claim 11, wherein the curl is a curl corresponding to a printing condition.

13. The method according to claim 11, wherein the curl is formed in a nip formed by pressing a hard roller and a soft roller against each other.

14. The method according to claim 13, wherein the curl is formed by a registration roller that controls timing if the recording medium is conveyed to the endless device.

15. The method according to claim 13, further comprising pressing the hard roller and the soft roller against each other with pressing force having magnitude corresponding to the printing condition, wherein
the nip between the hard roller and the soft roller forms, in the recording medium, a curl having a curl amount corresponding to the magnitude of the pressing force.

16. The method according to claim 15, further comprising:
storing, in a memory, magnitudes of pressing force associated with various printing conditions;
determining, according to information stored in the memory, magnitude of pressing force corresponding to a printing condition to be executed; and
pressing the hard roller and the soft roller against each other with the determined magnitude of the pressing force.

17. The method according to claim 11, wherein the curl is formed in a part of the recording medium.

18. The method according to claim 17, wherein the curl is formed at a leading end of the recording medium.

19. The method according to claim 17, wherein the curl is formed at a trailing end of the recording medium.

20. The method according to claim 17, wherein the curl is formed at a leading end and a trailing end of the recording medium.
